(19) United States
(12) Patent Application Publication
(10) Pub. No.: US 2024/0392593 A1
(43) Pub. Date: Nov. 28, 2024

(54) HYBRID DOME ATTRACTION

(71) Applicant: Kraftwerk Living Technologies GmbH, Wels (AT)

(72) Inventors: Manfred MEIER, Krenglbach (AT); Christian HOFER, Oftering (AT)

(73) Assignee: Kraftwerk Living Technologies GmbH, Wels (AT)

(21) Appl. No.: 18/695,854

(22) PCT Filed: Sep. 27, 2022
(86) PCT No.: PCT/AT2022/060335

§ 371 Date: Mar. 27, 2024

(30) Foreign Application Priority Data
Sep. 28, 2021 (CN) 202111145166.9

(51) Int. Cl. E04H 3/30; G06F 3/16; G09G 3/00; H04N 9/31

(52) U.S. Cl. CPC E04H 3/30; G06F 3/162; G09G 3/03; H04N 9/3147; G09G 2354/00

(57) ABSTRACT

A multimedia experience facility includes a first presentation unit, a second presentation unit, an auditorium having a base area, wherein the first presentation unit and the second presentation unit are assigned to the auditorium, and an audience area, wherein the audience area is arranged inside the auditorium, and wherein the audience area has a substructure and seats accommodated thereon, and wherein the arrangement of the seats establishes a main viewing direction in the audience area. A bearing apparatus is arranged in the auditorium, by which the substructure of the audience area can be pivoted relative to the base area of the auditorium in terms of its orientation such that the main viewing direction is oriented to the first presentation unit in a first configuration and the main viewing direction is oriented to the second presentation unit in a second configuration.

The invention relates to a multimedia experience facility.

Various multimedia experience facilities are known from the prior art.

The problem to be solved of the present invention was to create an improved multimedia experience facility.

This problem is solved by a device according to the claims.

A multimedia experience facility is configured in accordance with the invention. The multimedia experience facility comprises:
a first presentation unit
a second presentation unit
an auditorium having a base area, wherein the first presentation unit and the second presentation unit are assigned to the auditorium
an audience area, wherein the audience area is arranged inside the auditorium and wherein the audience area has a substructure and a plurality of seats accommodated thereon and wherein the arrangement of the seats establishes a main viewing direction in the audience area. A bearing apparatus is arranged in the auditorium, by means of which the substructure of the audience area can be pivoted relative to the base area of the auditorium in terms of its orientation
such that the main viewing direction is oriented to the first presentation unit in a first configuration
and the main viewing direction is oriented to the second presentation unit in a second configuration.

The multimedia experience facility according to the invention offers the advantage that two independent presentation units are provided, wherein the attention of the visitors of the present multimedia experience facility can be directed towards one of the two presentation units without having to reconfigure the audience area. In particular, it is possible to change the assignment with visitors present, preferably without the visitors having to change or leave their position or their seat in the audience area.

In this way, preparatory work can take place in the presentation unit not currently aligned in the main viewing direction without impairing actions in the aligned presentation unit. Afterwards, the orientation is changed such that only a very short interruption phase occurs for the visitor.

Furthermore, it can be expedient for a plurality of seating groups to be formed, wherein the seating groups each comprise a plurality of the seats, wherein the seats combined into a seating group are jointly accommodated on the substructure so as to be displaceable and/or pivotable relative to the substructure. This offers the advantage that an improved entertainment experience can be achieved by pivoting or tilting the individual seating groups.

Furthermore, it can be provided that the seats each have a media supply. This measure can achieve an improved entertainment experience. In a first embodiment, it can be provided that the media supply is configured in the form of a water supply. In an alternative embodiment, it can be provided that the media supply is configured in the form of a compressed air supply. In a further alternative embodiment, it can be provided that the media supply is configured the form of an electrical supply line or an electrical control line.

In addition, it can be provided that the substructure of the audience area is freely rotatable relative to the base area of the auditorium by an unlimited number of revolutions. This offers the advantage that the substructure of the audience area can always be rotated clockwise or always counterclockwise, for example, and does not have to be rotated back and forth between an initial position and an end position. As a result, the substructure of the audience area can be rotated such that the main viewing direction is rotated one after the other onto presentation units arranged on the circumference, wherein to achieve the shortest possible rotation time between the last presentation unit and the first presentation unit, the substructure of the audience area is simply rotated further in the previous direction of rotation.

Another embodiment is advantageous, according to which it can be provided that a sliding contact, which provides electrical transmission, is formed between the substructure of the audience area and the base area of the auditorium. The advantage of this measure is that the free rotatability of the substructure can be achieved and a transmission of electrical signals or a transmission of electrical power can be achieved at the same time.

According to an advancement, it is possible for the sliding contact to have first poles for electrical power transmission and further poles for electrical signal transmission. The advantage thereof is that the auditorium can have extensive functionality.

In an alternative embodiment, it can be provided that the signal transmission, for example for control signals, can take place via contactless signal transmission means, such as radio or WLAN. Of course, it is also conceivable for optical signal transmission to take place.

Furthermore, it can be expedient for a water storage to be arranged in the substructure of the audience area, effect nozzles being assigned to the seats and coupled to the water storage. This offers the advantage that the water required for the effect nozzles can be stored in the substructure of the audience area and thus no constant water supply from outside into the substructure is necessary. In an alternative embodiment, provision can also be made for a rotary feedthrough to be formed, by means of which a water line is guided into the substructure in order to enable uninterrupted supply of water from the outside into the substructure when the substructure is freely rotatable.

It can be additionally provided that a compressor is arranged in the substructure of the audience area, effect nozzles being assigned to the seats and coupled to the compressor. This offers the advantage that the compressed air required for the effect nozzles can be stored in the substructure of the audience area and thus no constant supply of compressed air from outside into the substructure is necessary. In an alternative embodiment, provision can also be made for a rotary feedthrough to be formed, by means of which a compressed air line is guided into the substructure in order to enable an uninterrupted supply of compressed air from the outside into the substructure when the substructure is freely rotatable.

It can further be provided that a third presentation unit is formed, wherein the first presentation unit and the third presentation unit are arranged in a first circular segment of the auditorium with respect to the base area of the auditorium, and the second presentation unit is arranged in a second circular segment of the auditorium, wherein the first circular segment spans a first circular segment angle between 140° and 180°. This offers an improved entertainment experience. This measure particularly allows a first show or pre-show to be presented in the first presentation unit in the presentation sequence. A second show or main show can be presented in the larger second presentation unit. It can particularly be provided that the second show is a multimedia presentation, in which moving images are displayed. A third show or post-show can be presented in the third presentation unit. In particular, provision can be made for the first show and the third show to last less time than the second show in terms of their presentation duration. Provision can also be made for a walk-on stage surface to be formed in the first presentation unit and/or in the third presentation unit.

According to a particular embodiment, it is possible for the second presentation unit to comprise a display surface which is configured in a dome shape, the display surface having an opening angle between 1800 and 2200 as viewed in cross section.

According to an advantageous advancement, it can be provided that the display surface comprises a plurality of light-emitting diodes. A display surface configured in this particular way is surprisingly well suited to improving the entertainment experience.

In particular, it can be advantageous for the light-emitting diodes to be arranged on a support structure, wherein the support structure is perforated and the light-emitting diodes are arranged at a light-emitting-diode distance from one another such that a plurality of continuous recesses are formed from a surface of the display surface to a rear side of the support structure. This offers the advantage that a large area can be configured as a display surface yet it is still possible for the sound quality that reaches the viewers to be sufficiently high, so as to improve the entertainment experience.

Furthermore, it can be provided that the display surface is configured as a projection surface and that a plurality of projectors are arranged in the auditorium, at least one of the projectors being arranged behind the display surface, wherein an opening is formed in the display surface, through which the projector projects onto an opposite region of the display surface. This offers the advantage that when the display surface is configured as a projection surface, the entire projection surface can be used for video projection.

In addition, it can be provided that the display surface is configured as a projection surface and that a plurality of projectors are arranged in the auditorium, the image being partially blacked out by at least one of the projectors at a certain angular position of the substructure of the audience area. As a result of this measure, when the audience area is pivoted between the various configurations, a projection in the second configuration that is necessary for a first configuration is partially hidden in order to best prevent glare for the viewers.

Another embodiment is advantageous, according to which it can be provided that an emergency escape staircase, which leads into the substructure of the audience area, is formed at the front of the audience area in the main viewing direction, wherein a circumferential emergency escape route is formed in the substructure of the audience area. This measure can increase personal safety in the multimedia experience facility.

According to a further advancement, it is possible for at least one first emergency escape staircase and one second emergency escape staircase to be formed, wherein a lowerable wheelchair transport platform is formed in the region of the first emergency escape staircase. This offers the advantage that safe access to and safe exit from the multimedia experience facility can also be achieved for persons with reduced mobility.

Furthermore, it can be expedient for a technical room, which is enclosed by the circumferential emergency escape route, is arranged in the substructure of the audience area. This measure offers the advantage that a technical room can be installed whilst maintaining a sufficiently good emergency escape route situation.

In particular, the technical room can be provided to accommodate the water storage. It can be further provided that the compressor is arranged in the technical room.

In addition, it can be provided that a railing is arranged between individual seat rows or at the edge of the audience area, the railing being transparent or translucent. This offers the advantage that a sufficiently high level of personal safety can be achieved and, at the same time, the safety rail does not negatively impact the multimedia entertainment experience.

Furthermore, it can be provided that the railing serves as an additional display surface. This has the advantage of further improving the multimedia entertainment experience. In particular, a 3D effect can be achieved by displaying an image on a railing located in front of the main display surface.

According to a particular embodiment, it is possible for a plurality of loudspeakers to be arranged at an evenly distributed distance from one another in the auditorium and for a digital computer to be formed, wherein the audio output to the loudspeakers can be calculated using the digital computer depending on the pivot angle position of the audience area. This offers the advantage that the same loudspeakers can be used for all configurations with different orientations of the main viewing direction, thus minimising installation work and costs. In addition, this measure allows high audio quality to be achieved in all different configurations.

The figures below elaborate on the invention to offer better understanding thereof.

The figures show in greatly simplified, schematic depiction:

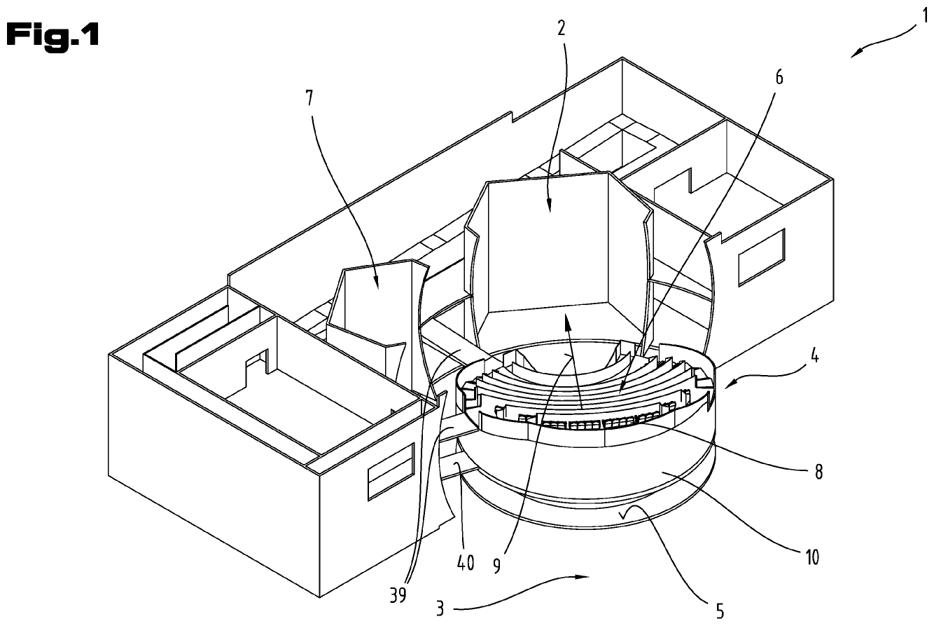

FIG. 1 a perspective view of a first embodiment of a multimedia experience facility

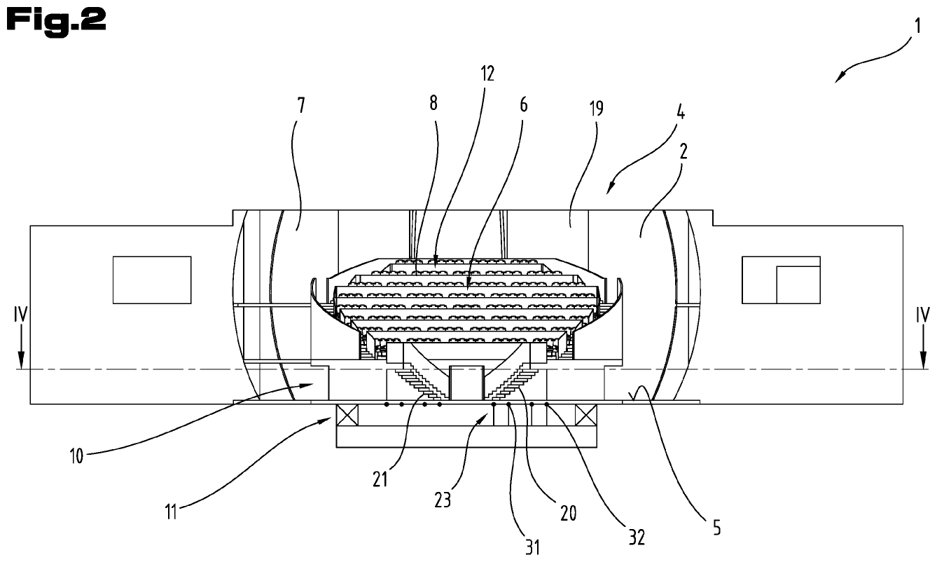

FIG. 2 an outline of the multimedia experience facility of the first embodiment

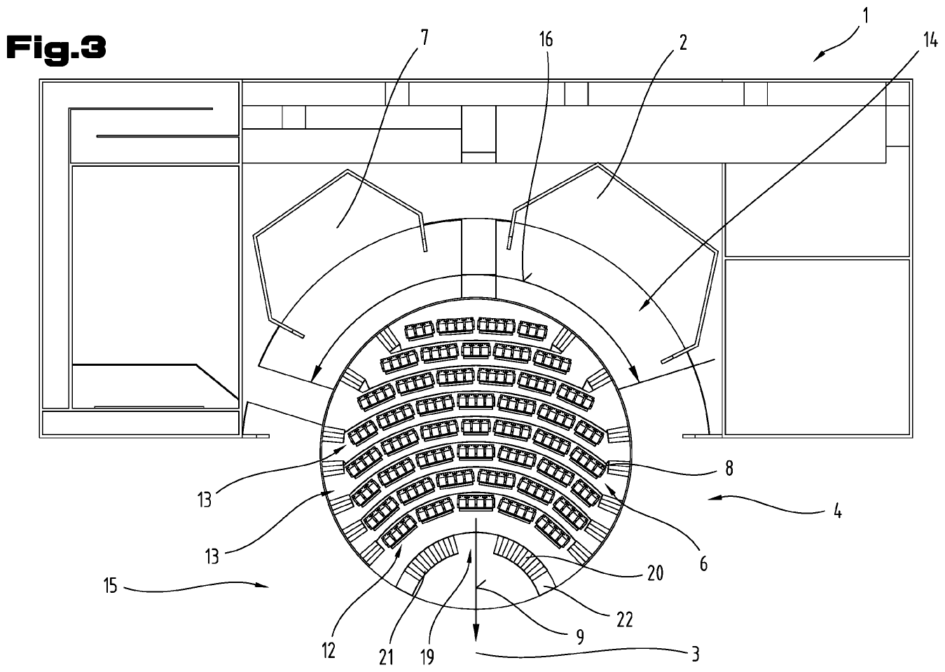

FIG. 3 a floor plan of the multimedia experience facility of the first embodiment

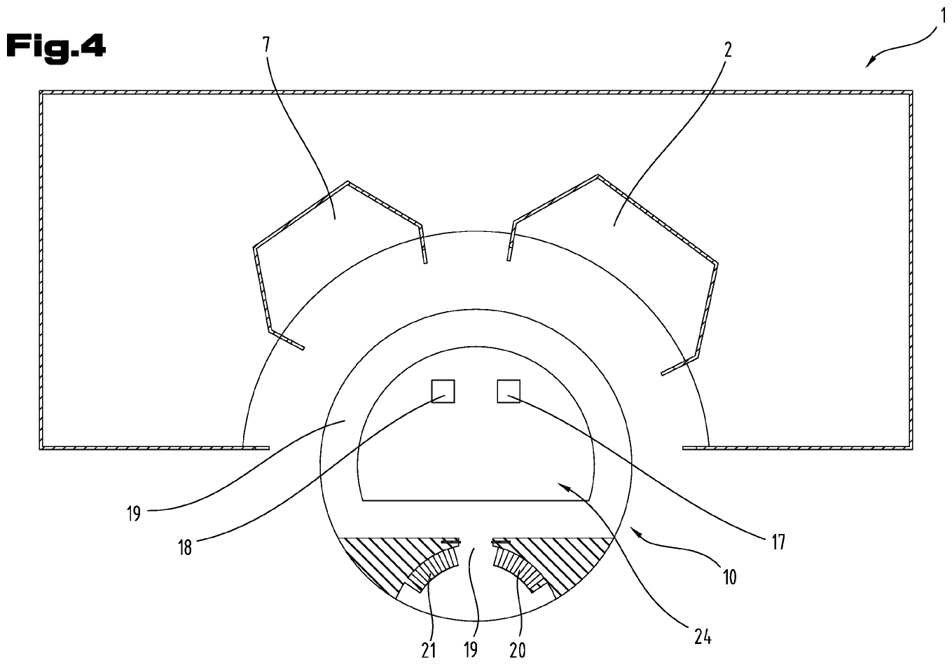

FIG. 4 a sectional view of the multimedia experience facility of the first embodiment according to the section line IV-IV of FIG. 2

FIG. 5 a half-section view of the multimedia experience facility of the first embodiment

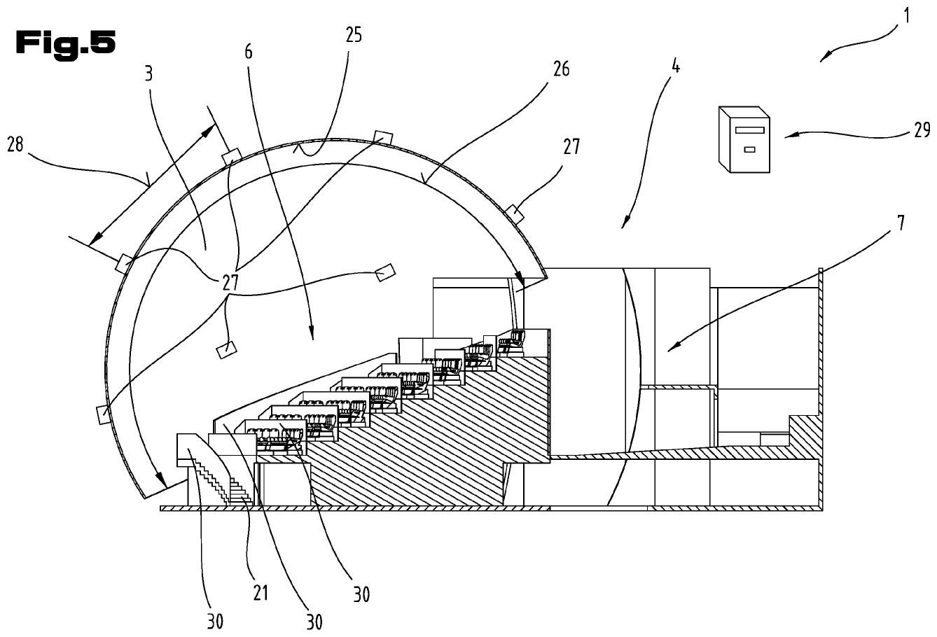

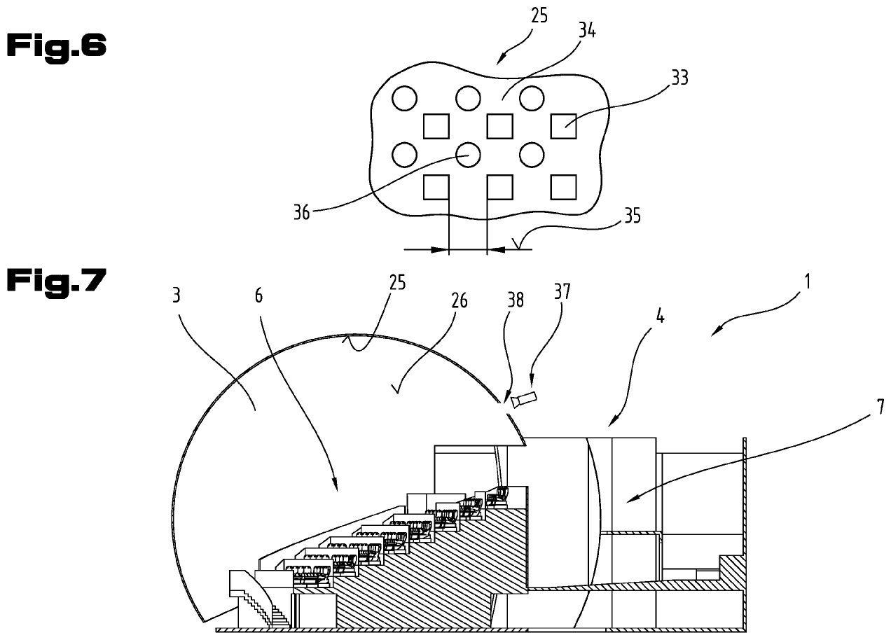

FIG. 6 an embodiment of the display surface with light-emitting diodes

FIG. 7 a half-section view of the multimedia experience facility of a further embodiment

It is worth noting here that the same parts have been given the same reference numerals or same component designations in the embodiments described differently, yet the disclosures contained throughout the entire description can be applied analogously to the same parts with the same reference numerals or the same component designations. The indications of position selected in the description, such as above, below, on the side etc. refer to the figure directly described and shown, and these indications of position can be applied in the same way to the new position should the position change.

FIG. 1 shows a perspective view of a first embodiment of a multimedia experience facility 1.

FIG. 2 shows an outline of the multimedia experience facility 1 of the first embodiment.

FIG. 3 shows a floor plan of the multimedia experience facility 1 of the first embodiment.

FIG. 4 shows a sectional view of the multimedia experience facility 1 of the first embodiment according to the section line IV-IV of FIG. 2.

FIG. 5 shows a half-section view of the multimedia experience facility 1 of the first embodiment.

A combination of FIG. 1 to 5 is used in the description, wherein the same reference numerals or component designations as in the preceding figures are used for the same parts.

The multimedia experience facility 1 comprises a first presentation unit 2 and a second presentation unit 3 separate therefrom. A third presentation unit 7 can further be provided.

The multimedia experience facility 1 further comprises an auditorium 4 having a base area 5, wherein the first presentation unit 2 and the second presentation unit 3 and the third presentation unit 7 are assigned or turned towards to the auditorium 4.

An audience area 6 is further provided in the region of the base area 5 of the auditorium 4. The audience area 6 is arranged on a substructure 10.

A plurality of seats 8 is arranged in the audience area 6. The arrangement of the seats 8 is selected such that the perspective of the visitors who have sat in the seats 8 is directed or oriented such that the viewing directions of all persons define a main viewing direction 9.

This main viewing direction 9 directs the attention of the auditorium to the presentation unit 2, 3, 7 assigned to the respective configuration.

FIG. 1 shows the multi-purpose event facility 1 in a first configuration, in which the audience area 6, in particular the main viewing direction 9, is oriented in the direction of the first presentation unit 2. As can also be seen in FIG. 1, it can be provided that the audience area 6 is accessible via one entrance 39 or a plurality of entrances 39 in the first configuration.

FIG. 2 to 5 show the multi-purpose event facility 1 in a second configuration, in which the audience area 6, in particular the main viewing direction 9, is oriented in the direction of the second presentation unit 3.

In order to change the configuration, provision is made for the multimedia experience facility 1 to have a bearing device 11, which accommodates the audience area 6, in particular the substructure 10 relative to the auditorium 4, such that its orientation can be changed. According to a preferred embodiment, the audience area 6 is configured as a revolving auditorium. Thus, by means of the bearing device 11, the audience area 6 can be rotated about a central point of the audience area 6 relative to the fixed auditorium 4. In particular, rotation is possible such that the main viewing direction 9 is directed towards the first presentation unit 2 in the first configuration, in the second configuration towards the second presentation unit 3 and in the third configuration toward the third presentation unit 7.

It can particularly be provided that, as seen in the plan view of the multimedia experience facility 1, the first presentation unit 2, the second presentation unit 3 and the third presentation unit 7 are arranged in this order in the clockwise direction. The audience area 6 can be rotated clockwise relative to the main viewing direction 9 in order to present different shows to the visitors in the first presentation unit 2, in the third presentation unit 7 and in the second presentation unit 3.

As further shown in FIG. 1 to 4, it can be provided that individual seats 8 can each be combined into a seating group 12. In particular, the seating group 12 can comprise a seating group frame, upon which the individual seats 8 are arranged.

It can further be provided that the individual seats 8 are arranged in a plurality of seat rows 13. The individual seat rows 13 can be arranged at different levels, wherein rear seat rows 13 in the main viewing direction 9 can be arranged at a higher level than front seat rows 13 in the main viewing direction 9.

As can clearly be seen in FIG. 3, it can be provided that a first circular segment 14 is formed and a second circular segment 15 is formed with respect to the floor plan. The first presentation unit 2 and the third presentation unit 7 can be arranged in the first circular segment 14. The second presentation unit 3 can be arranged in the second circular segment 15. For the sake of clarity, the second presentation unit 3 is not shown in more detail in FIG. 1 to 4 but is only shown as from FIG. 5.

As can further be seen in FIG. 3, it can be provided that the first circular segment 14 spans a first circular segment angle 16.

As is particularly clear in FIGS. 2, 3 and 4, it can be provided that an emergency escape route 19 is formed in a lower level. The emergency escape route 19 can be formed circumferentially.

The emergency escape route 19 can be accessible from the audience area 6 via a first emergency escape staircase 20 and a second emergency escape staircase 21. Furthermore, provision can be made for a wheelchair transport platform 22, which can serve to transport persons with reduced mobility, to be formed in the region of the first emergency escape staircase 20.

As shown in FIG. 4, it can be provided that a technical room 24 is arranged centrally in the substructure 10 of the audience area 6. The emergency escape route 19 can be formed circumferentially around the technical room 24.

It can further be provided that the emergency escape route 19 is connected to an exit 40, as shown in FIG. 1.

It can particularly be provided that easy access to the exit 40 is possible when the main viewing direction 9 in the third configuration is guided to the third presentation unit 7.

It can be further provided that a compressor 18 for providing compressed air is arranged in the technical room 24.

It can further be provided that a water storage 17 for providing water is arranged in the technical room 24. The water storage 17 can be sized such that it provides a water supply for one day.

As can be seen in FIG. 5, it can be provided that the second presentation unit 3 has a display surface 25, which serves to display a moving image. The display surface 25 can be configured in the form of a spherical segment or spherical dome. In particular, it can be provided that the display surface 25 has an opening angle 26 in a cross section through the central point of the spherical dome. The opening angle 26 can be greater than 180°, such that the spherical dome is larger than in the form of a hemisphere.

It can further be provided that loudspeakers 27, which are used to provide sound to the audience area 6, are arranged in a distributed manner across the entire auditorium 4. The loudspeakers 27 can be arranged at a distance 28 from one another and distributed regularly. The loudspeakers 27 can be controlled by a digital computer 29 such that the best possible sound experience can be delivered in any configuration or orientation of the audience area 6, which is matched with the current main viewing direction 9.

It can further be provided that one of the railings 30, which is arranged between the individual seat rows 13 or at the edge of the audience area 6, serves as an additional display surface. In this case, it can particularly be provided that the front railing(s) 30, which are arranged in the region of the emergency escape staircases 20, 21, serve as an additional display surface in order to offer an improved entertainment experience.

As can also be seen in FIG. 2, provision can be made for a sliding contact 23 to be formed, having first poles 31 to transmit electrical power from the auditorium 4 to the substructure 10 of the audience area 6. In this case, it can be particularly provided that a rotatable electrical connection or a power supply of the substructure 10 is achieved by the sliding contact 23.

It can further be provided that the sliding contact 23 has further poles 32 to electrically transmit signals.

FIG. 6 shows a further, optionally independent embodiment of the display surface 25, however the same reference numerals or component designations as in the preceding FIGS. 1 to 5 are used again for identical parts. To avoid unnecessary repetition, reference is made to the detailed description in the preceding FIGS. 1 to 5.

FIG. 6 shows a detail view of an embodiment of the display surface 25.

As can be seen in FIG. 6, it can be provided that a plurality of light-emitting diodes 33 are formed, which are accommodated on a support structure 34. The light-emitting diodes 33 can be arranged at a light-emitting-diode distance 35 from one another. Furthermore, it can be provided that recesses 36, which penetrate through the support structure 34, are formed between the individual light-emitting diodes 33 in the support structure 34. As a result of this measure, the display surface 25 can be sound permeable, such that loudspeakers 27 arranged behind the display surface 25 can provide sound to the audience area 6.

FIG. 7 shows a further, optionally independent embodiment of the multimedia experience facility 1, wherein the same reference numerals or component designations as in the preceding FIGS. 1 to 6 are used again for identical parts. To avoid unnecessary repetition, reference is made to the detailed description in the preceding FIGS. 1 to 6.

As can be seen in FIG. 7, it can be provided that the display surface 25 is configured as a projection surface and that a plurality of projectors 37, which serve to display images on the display surface 25, are arranged in the auditorium 4. It can particularly be provided that one of the projectors 37 is arranged behind the display surface 25, wherein an opening 38 is formed in the display surface 25, through which the projector projects onto an opposite region of the display surface. The one opening 38 can be closable. In particular, it can be provided that the opening 38 can be closed automatically by means of an actuator. A shutter or panel or cover can be shifted in front of or behind the opening 38 for this purpose.

Furthermore, it is also conceivable for a material to be formed in the opening 38, which is translucent from one side, such that the light emitted by the projector 37 can pass through the opening 38 and which, when irradiated from the second side, can serve as a projection surface.

The exemplary embodiments show possible embodiment variations, although it is to be noted here that the invention is not limited to the specifically represented embodiment variations of the same, but rather various combinations of the individual embodiment variations with one another are possible, and that given the technical teachings provided by the present invention this variation possibility is within the ability of the skilled person in this technical field.

The scope of protection is determined by the claims. However, the description and the drawings are to be referenced for the interpretation of the claims. Individual features or combinations of features from the various exemplary embodiments shown and described can represent independent inventive solutions in themselves. The problem to be solved, upon which the independent, inventive solutions are based, can be derived from the description.

All value ranges specified in the current description are to be understood such that they include any and all sub-ranges, e.g., the specification 1 to 10 is to be understood such that all sub-ranges, starting from the lower limit 1 and the upper limit 10 are included, i.e., all sub-ranges begin with a lower limit of 1 or more and end at an upper limit of 10 or less, e.g., 1 to 1.7, or 3.2 to 8.1, or 5.5 to 10.

As a matter of form and by way of conclusion, it is noted that, to improve understanding of the structure, elements have partially not been shown to scale and/or enlarged and/or shrunk.

### LIST OF REFERENCE NUMERALS

| | |
|---|---|
| 1 | Multimedia experience facility |
| 2 | First presentation unit |
| 3 | Second presentation unit |
| 4 | Auditorium |
| 5 | Base area |
| 6 | Audience area |
| 7 | Third presentation unit |
| 8 | Seat |
| 9 | Main viewing direction |
| 10 | Substructure |
| 11 | Bearing device |
| 12 | Seating group |
| 13 | Seat row |
| 14 | First circular segment |
| 15 | Second circular segment |
| 16 | First circular segment angle |
| 17 | Water storage |
| 18 | Compressor |
| 19 | Emergency escape route |
| 20 | First emergency escape staircase |
| 21 | Second emergency escape staircase |
| 22 | Wheelchair transport platform |
| 23 | Sliding contact |
| 24 | Technical room |
| 25 | Display surface |
| 26 | Opening angle |
| 27 | Loudspeakers |
| 28 | Distance |
| 29 | Digital computer |
| 30 | Railing |
| 31 | First poles |
| 32 | Further poles |
| 33 | Light-emitting diode |
| 34 | Support structure |
| 35 | Light-emitting-diode distance |
| 36 | Recess |
| 37 | Projector |
| 38 | Opening |
| 39 | Entrance |
| 40 | Exit |

1: A multimedia experience facility (1) comprising:
a first presentation unit (2)
a second presentation unit (3)
an auditorium (4) having a base area (5), wherein the first presentation unit (2) and the second presentation unit (3) are assigned to the auditorium (4)
an audience area (6), wherein the audience area (6) is arranged inside the auditorium (4) and wherein the audience area (6) has a substructure (10) and a plurality of seats (8) accommodated thereon and wherein the arrangement of the seats (8) establishes a main viewing direction (9) in the audience area (6)
wherein
a bearing apparatus (11) is arranged in the auditorium (4), by means of which the substructure (10) of the audience area (6) can be pivoted relative to the base area (5) of the auditorium (4) in terms of its orientation
such that the main viewing direction (9) is oriented to the first presentation unit (2) in a first configuration
and the main viewing direction (9) is oriented to the second presentation unit (3) in a second configuration.

2: The multimedia experience facility (1) according to claim 1, wherein a plurality of seating groups (12) are formed, wherein the seating groups (12) each comprise a plurality of the seats (8), wherein the seats (8) combined into a seating group (12) are jointly accommodated on the substructure (10) so as to be displaceable and/or pivotable relative to the substructure (10).

3: The multimedia experience facility (1) according to claim 1, wherein the seats (8) each have a media supply.

4: The multimedia experience facility (1) according to claim 1, wherein the substructure (10) of the audience area (6) is freely rotatable relative to the base area (5) of the auditorium (4) by an unlimited number of revolutions.

5: The multimedia experience facility (1) according to claim 1, wherein a sliding contact (23), which provides electrical transmission, is formed between the substructure (10) of the audience area (6) and the base area (5) of the auditorium (4).

6: The multimedia experience facility (1) according to claim 5, wherein the sliding contact (23) has first poles (31) for electrical power transmission and further poles (32) for electrical signal transmission.

7: The multimedia experience facility (1) according to claim 1, wherein a water storage (17) is arranged in the substructure (10) of the audience area (6), effect nozzles being assigned to the seats (8) and coupled to the water storage (17).

8: The multimedia experience facility (1) according to claim 1, wherein a compressor (18) is arranged in the substructure (10) of the audience area (6), effect nozzles being assigned to the seats (8) and coupled to the compressor (18).

9: The multimedia experience facility (1) according to claim 1, wherein a third presentation unit (7) is formed, wherein the first presentation unit (2) and the third presentation unit (7) are arranged in a first circular segment (14) of the auditorium (4) with respect to the base area (5) of the auditorium (4), and the second presentation unit (3) is arranged in a second circular segment (15) of the auditorium (4), wherein the first circular segment (14) spans a first circular segment angle (16) between 140° and 180°.

10: The multimedia experience facility (1) according to claim 1, wherein the second presentation unit (3) comprises a display surface (25), which is configured in a dome shape, the display surface (25) having an opening angle (26) between 180° and 220° as viewed in cross section.

11: The multimedia experience facility (1) according to claim 10, wherein the display surface (25) comprises a plurality of light-emitting diodes (33).

12: The multimedia experience facility (1) according to claim 11, wherein the light-emitting diodes (33) are arranged on a support structure (34), wherein the support structure (34) is perforated and the light-emitting diodes (33) are arranged at a light-emitting-diode distance (35) from one another such that a plurality of continuous recesses (36) are formed from a surface of the display surface (25) to a rear side of the support structure (34).

13: The multimedia experience facility (1) according to claim 10, wherein the display surface (25) is configured as a projection surface and wherein a plurality of projectors (37) are arranged in the auditorium (4), at least one of the projectors (37) being arranged behind the display surface (25), wherein an opening (38) is formed in the display surface (25), through which the projector (37) projects onto an opposite region of the display surface (25).

14: The multimedia experience facility (1) according to claim 10, wherein the display surface (25) is configured as a projection surface and wherein a plurality of projectors (37) are arranged in the auditorium (4), the image being partially blacked out by at least one of the projectors (37) at a certain angular position of the substructure (10) of the audience area (6).

15: The multimedia experience facility (1) according to claim 1, wherein an emergency escape staircase (20, 21), which leads into the substructure (10) of the audience area (6), is formed at the front of the audience area (6) in the main viewing direction (9), wherein a circumferential emergency escape route (19) is formed in the substructure (10) of the audience area (6).

16: The multimedia experience facility (1) according to claim 15, wherein at least one first emergency escape staircase (20) and one second emergency escape staircase (21) are formed, wherein a lowerable wheelchair transport platform (22) is formed in the region of the first emergency escape staircase (20).

17: The multimedia experience facility (1) according to claim 15, wherein a technical room (24), which is enclosed by the circumferential emergency escape route (19), is arranged in the substructure (10) of the audience area (6).

18: The multimedia experience facility (1) according to claim 1, wherein a railing (30) is arranged between individual seat rows (13) or at the edge of the audience area (6), the railing (30) being transparent or translucent.

19: The multimedia experience facility (1) according to claim 18, wherein the railing (30) serves as an additional display surface.

20: The multimedia experience facility (1) according to claim 1, wherein a plurality of loudspeakers (27) are arranged at an evenly distributed distance (28) from one another in the auditorium (4), and wherein a digital computer (29) is configured, wherein the audio output to the loudspeakers (27) can be calculated using the digital computer (29) depending on the pivot angle position of the audience area.
